(19) United States
(12) Patent Application Publication
(10) Pub. No.: US 2006/0062132 A1
(43) Pub. Date: Mar. 23, 2006

(54) Thermally-assisted recording medium with a storage layer of antiferromagnetic double-layer structure with anti-parallel orientation of magnetization

(75) Inventor: Hans Willem Van Kesteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/532,920

(22) PCT Filed: Sep. 26, 2003
(86) PCT No.: PCT/IB03/04275

§ 371 Date: Apr. 27, 2005

(30) Foreign Application Priority Data
Nov. 1, 2002 (EP) 02079582.9

(51) Int. Cl. G11B 7/24

(52) U.S. Cl. 369/275.1; 369/283

(57) ABSTRACT

The present invention relates to a thermally-assisted recording medium comprising a storage layer consisting of a double-layer structure of antiferromagnetically coupled first (SL1) and second (SL3) layers with substantially the same composition, wherein the first and second layers are adapted to have an antiparallel orientation of magnetization. Due to the antiparallel orientation of the magnetization of the two layers during cooling down, subdomain formation is suppressed and uniformely magnetized domains can be written with a reduced external field. This has main advantages for power consumption of portable applications and opens the possibility to apply magnetic field coils for recording at higher data rates.

The present invention relates to a thermally-assisted recording medium, such as a magneto-optical or a thermally-assisted magnetic recording disc, comprising a storage layer for thermally-assisted writing information to said recording medium.

Magneto-Optical (MO) storage applies a focussed laser beam in combination with a magnetic field. The readback signal is based on polarization changes in the reflected light. MO recording offers the advantage over phase-change recording that marks with a dimension well below the diffraction limit can be written and read out. In order to broaden the application field of MO recording the areal density should be further increased and the field sensitivity of the recording layer should be improved. In MO recording small bits are written by using laser pulsed magnetic field modulation (LP-MFM). In LP-MFM, bit transitions are determined by the switching of a magnetic field and the temperature gradient induced by the switching of a laser. For readout of the small crescent shaped marks recorded in this way magnetic super resolution (MSR) or domain expansion (DomEx) methods have to be used. These technologies are based on recording media with several magneto-static or exchange coupled rare-earth transition-metal (RE-TM) layers. A readout layer on the disc masks adjacent bits during reading (MSR) or expands the domain in the center of the laser spot (DomEx). An advantage of DomEx over MSR is that bits with a dimension well below the diffraction limit can be detected with a similar signal-to-noise ratio (SNR) as bits with a size comparable to the diffraction limited spot.

AC-MAMMOS (Alternating-Current Magnetic Amplifying Magneto-Optical System) is a DomEx method which is based on a magneto-statically coupled storage and expansion or readout layer. In an AC-MAMMOS disc, a domain in the storage layer is coupled to the readout layer through a non-magnetic intermediate layer, and the copied domain is expanded to a size larger than the diameter of the laser spot by using the external magnetic field. In the readout process, a small recorded domain is selectively copied to the readout layer and then expanded in the readout layer by the external magnetic field. Thus, a large signal is obtained by reproducing the expanded domain. After that, the expanded domain can be removed in the readout layer by applying a reverse external magnetic field.

In ZF-MAMMOS (Zero-Field MAMMOS), a later developed DomEx technology, a domain in the storage layer is coupled to the readout layer through a magnetic trigger layer, and the copied domain is expanded to a size comparable to the diameter of the laser spot and subsequently collapsed as a consequence of the changing balance of the de-magnetizing and stray-field forces on the domain wall. No external field is required for the readout process.

Domain Wall Displacement Detection (DWDD) is a DomEx method based on an exchange coupled storage and readout layer. In DWDD, marks recorded in the storage layer are transferred to a readout or displacement layer via an intermediate magnetic switching layer as a result of exchange coupling forces. The temperature rises when a reproducing laser spot is irradiated onto a track on the disc. When the switching layer exceeds the Curie temperature, the magnetization is lost, causing the exchange coupling force between each layer to disappear. The exchange coupling force is one of the forces holding the transferred marks in the displacement layer. When it disappears, the domain wall in the displacement layer shift to a high temperature section which has low domain wall energy, allowing small recorded marks to expand. This allows reading with a laser beam, even if recordings have been made at high density.

Thermally-assisted or heat-assisted magnetic recording applies a small laser spot on the medium in combination with a magnetic field for writing. However, in contrast to MO recording the readback signal is based on the detection of the stray-field of the recorded marks by a magneto-resistance sensor. For thermally-assisted magnetic recording the storage layer should enable high-density writing at elevated temperatures with preferably low recording fields.

The storage and readout layers applied in MO recording media are based on rare-earth (RE) transition-metal (TM) alloys like TbFeCo and GdFeCo. For thermally-assisted magnetic recording TbFeCo alloys also form an interesting recording material. RE-TM layers are ferrimagnetic with opposite magnetization directions of the RE and TM sub-lattices. Ferrimagnetism is a form of magnetism occurring in those antiferromagnetic materials, in which the microscopic magnetic moments are aligned antiparallel but are not equal. By suitable choice of the RE element and the composition it is possible to design ferrimagnetic substances with specific anisotropy, magnetization and temperature dependence of the magnetic properties. For the storage layer the composition is chosen in such a way that a perpendicular magnetic anisotropy is obtained. By depositing two RE-TM layers on top of each other they can be easily exchange coupled. The lowest energy state is usually the state in which the sub-lattices in both layers have the same orientation. However, when one layer is RE-rich and the other TM-rich the net magnetization in the two layers will be opposite. This direct exchange coupling of RE-TM layers and the magnetostatic coupling of RE-TM layers over a non-magnetic dielectric layer forms the basis of all known super resolution readout technologies in MO recording. The direct exchange coupling of a TbFeCo/GdFeCo bi-layer or double-layer is also used to increase the field sensitivity of the media for LP-MFM recording.

For ferromagnetic thin films also antiferromagnetic or ferrimagnetic behavior can be obtained by coupling two ferromagnetic thin films over for instance a thin non-magnetic Ru layer. This effect is applied for biasing GMR and TMR elements in sensors and magnetic random access memories (MRAMs). The use of antiferromagnetic coupling of ferromagnetic storage layers for hard disk storage is also known and applied in state of the art hard disk drive (HDD) products to increases the magnetic stability of the storage layers. In this case, two ferromagnetic in-plane magnetized Co-alloy films are coupled anti-ferromagnetically over a Ru layer. Document U.S. Pat. No. 5,756,202 discloses an antiferromagnetic coupling of two ferromagnetic perpendicular magnetized Co/Pt multilayer stacks over e.g. a Ru layer, which can be used for super resolution and direct-overwrite MO recording.

Furthermore, document U.S. Pat. No. 6,150,038 discloses a DWDD medium with a storage layer which can consist of two sublayers. These two sublayers have a composition adjusted in such a way that one sublayer is RE-rich and the other TM-rich in the temperature range from room temperature to the writing temperature. With the magnetizations of the two sublayers antiparallel the stray field on the expansion layer is small which leads to a better expansion process. As an example, a combination of a TbFeCo storage layer and a GdFeCo layer is mentioned. This enables to write data in the TbFeCo layer with a lower field. However, the main disadvantage of this approach is that two RE-TM sublayers with quite different compositions have to be used for the storage layer. If one of the layers has been optimized on a high anisotropy, the other will have a lower anisotropy. This lower average anisotropy will give problems when small bits have to be written and kept stable.

LP-MFM writing is a powerful recording method for increasing the linear density. However, the LP-MFM technology requires a magnetic field coil for modulating the external field. The power consumption for driving the magnetic field coil presents a problem for portable applications. Furthermore, for high data write applications it becomes increasingly difficult to switch the required high current in a sufficiently short time. Both problems can be solved by using media with an increased field sensitivity. For instance, increasing the field sensitivity by a factor of two means that the current through the coil can be reduced by a factor of two and the power can be reduced by a factor of four.

Conventional TbFeCo storage media require a magnetic field of 16 kA/m or more. A number of methods are known to increase the field sensitivity to a level of 8 kA/m. The interface(s) of the TbFeCo layer can be modified for instance by introducing some nitrogen in the sputter chamber at an appropriate moment, or the TbFeCo layer can be exchange-coupled to a thin GdFeCo layer with a small anisotropy around the Curie temperature. However, the problem with these methods is that they reduce the effective anisotropy of the storage layer. This anisotropy is an important parameter because it determines the width, regularity and stability of the bit transitions. Thus, it is questionable if these methods work for high recording densities such as 10-100 Gb per square inch.

The problem of regularity and stability of the transitions might also become relevant for the non-field sensitivity enhanced storage layers at densities of 10-100 Gb per square inch. At the readout temperature the magnetization of the storage layer is locally increased giving rise to demagnetizing forces on the domain wall. If the anisotropy and pinning forces are not sufficiently strong, these demagnetizing forces can move the domain wall to slightly different positions leading to increased transition jitter levels. A similar effect can occur during thermally assisted witing in MO as well as in thermally-assisted magnetic recording. During cooling down the position of the just formed transition in the storage layer can shift or deform due to de-magnetizing forces on the wall. During readout this can lead to bit errors.

It is an object of the present invention to provide a thermally assisted recording medium and manufacturing method, by means of which the required power consumption of the magnetic coil can be reduced and bit transitions can be stabilized to allow high recording densities.

This object is achieved by a thermally-assisted recording medium as claimed in claim 1 and a manufacturing method as claimed in claim 11.

Accordingly, an antiferromagnetic double-layer structure with substantially same magnetic properties of the sublayers is suggested as storage layer for thermally-assisted recording. Due to the antiparallel orientation of the magnetization of the two sublayers during cooling down, de-magnetizing fields are reduced and subdomain formation is suppressed. So, uniformly magnetized domains can be written with a reduced external field. This has main advantages for power consumption of portable applications and opens the possibility to apply magnetic field coils for recording at higher data rates. Moreover, the reduced de-magnetizing field leads to sharper transitions and reduced transition shifts during recording. The transition shift will also become independent of the just recorded data pattern. These effects support an increase in recording density. The lower stray field generated by the storage layer can be advantageous in DomEx stack arrangements, e.g. in DWDD applications. Because the stray field is independent of the composition of the layers when the sublayers are in an antiparallel alignment, the composition can be optimized on obtaining the highest possible storage density without compromising on stray field effects as in the single layer case.

The antiferromagnetic coupling of the two sublayers with substantially the same magnetic properties is obtained by coupling the sublayers over a non-magnetic metallic interlayer of a suitable material and thickness. Preferably Ru is used for the interlayer with a thickness around 0.9 nm because a layer of this material and with this thickness induces a strong antiferromagnetic coupling. Other coupling materials like V, Cr, Mn, Cu, Nb, Mo, Rh, Ta, W, Re, Os, Ir and mixtures thereof can in principle be used as well.

The storage layer is preferably based on a rare-earth transition-metal alloy like TbFeCo with a high perpendicular anisotropy and a Curie temperature around the writing temperature of 200-400° C. Other storage materials with a perpendicular anisotropy like Co/Pd multilayers or CoPdX, CoPtX, FePtX alloys where X denotes small percentage additions, can however be applied as well.

The coupling strength over the non-magnetic interlayer may be enhanced by choosing appropriate interface layers between the storage sublayers and the interlayer. For a TbFeCo storage layer, interface layers of Th, Fe, Co or FeCo can be used. Interface layers can also be used to prevent diffusion of the interlayer into the storage sublayers during thermally assisted recording.

The antiparallel orientation should correspond to the lowest energy state of the first and second layers in a temperature range between room temperature and writing temperature. This is easily accomplished for typical TbFeCo storage layer thicknesses and coupling strengths over Ru because during cooling down the antiferromagnetic coupling dominates over any other magnetostatic interaction as soon as the lowest Curie temperature of the two sublayers is passed. To enable writing the properties of the first and second layers may be differentiated by providing the layers with slightly different properties for instance thickness and/or adapting the first and second layers to have different Curie temperatures.

Furthermore, the double layer structure may be incorporated in an MSR or DomEx stack. In the following, the present invention will be described in greater detail on the basis of preferred embodiments with reference to the accompanying drawings, in which:

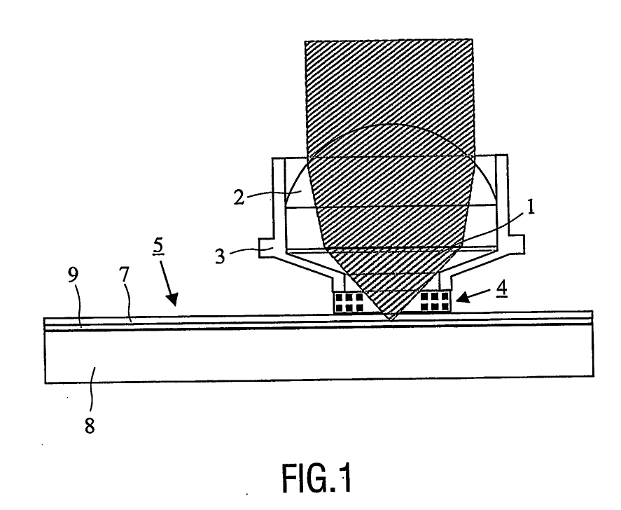

FIG. 1 shows a schematic diagram of a MO recording configuration;

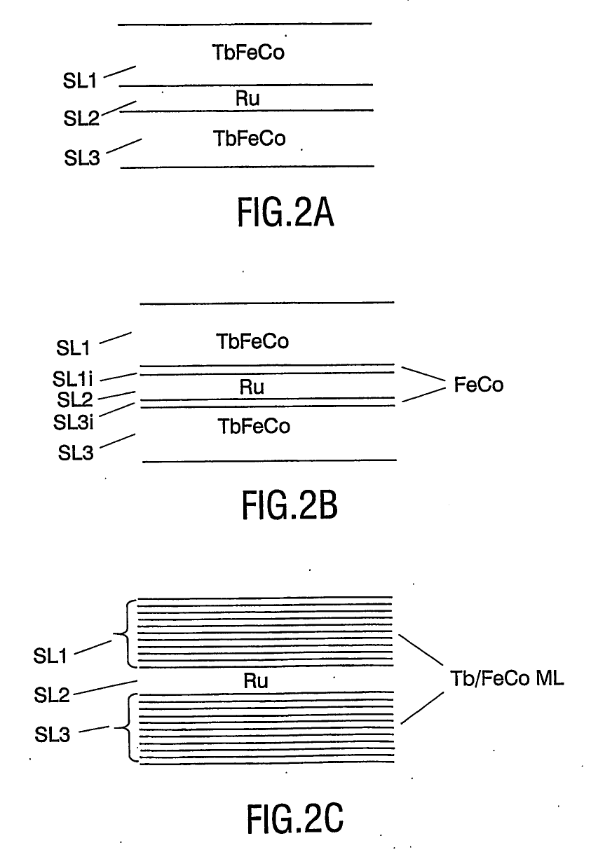

FIGS. 2A, 2B and 2C show schematic structures of a storage layer according to preferred embodiments of the present invention;

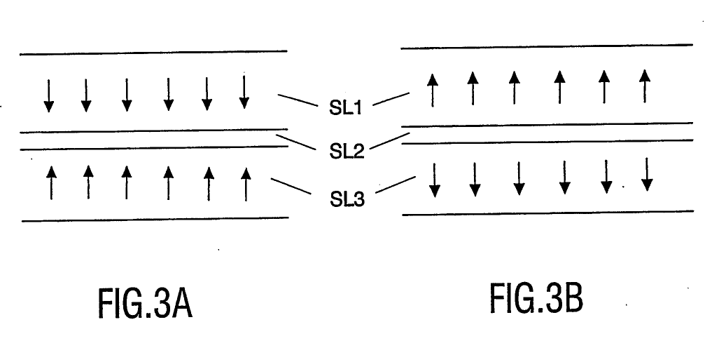

FIGS. 3A and 3B show antiparallel orientations of a double-layer structure according to the preferred embodiment of the present invention;

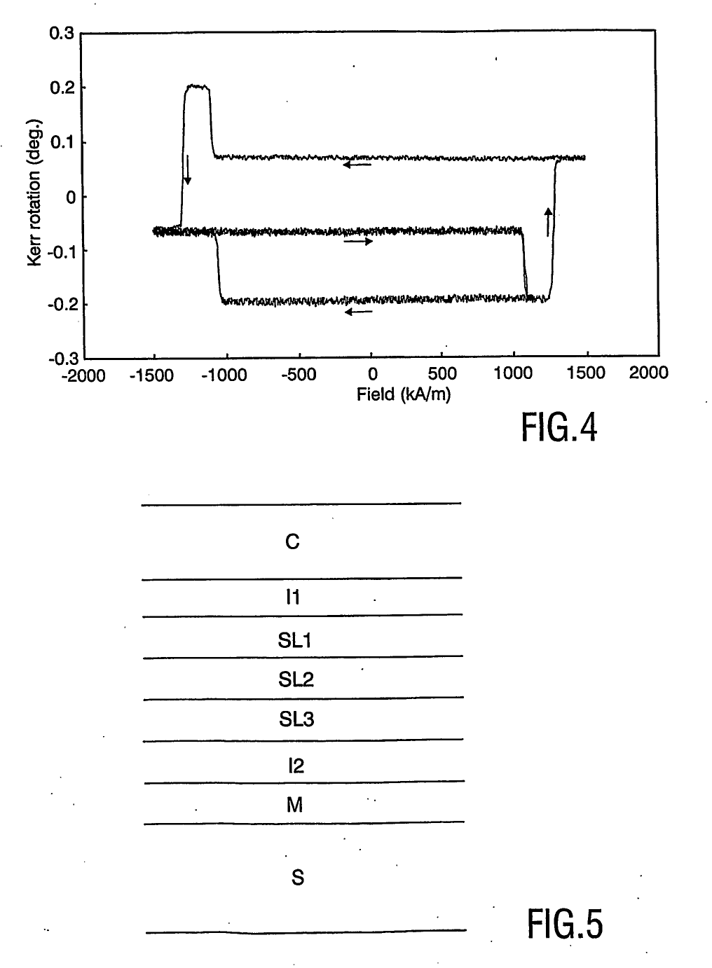

FIG. 4 shows a hysteresis loop of a TbFeCo/Ru/TbFeCo layer stack;

FIG. 5 shows a layer structure on a disk for conventional MO recording;

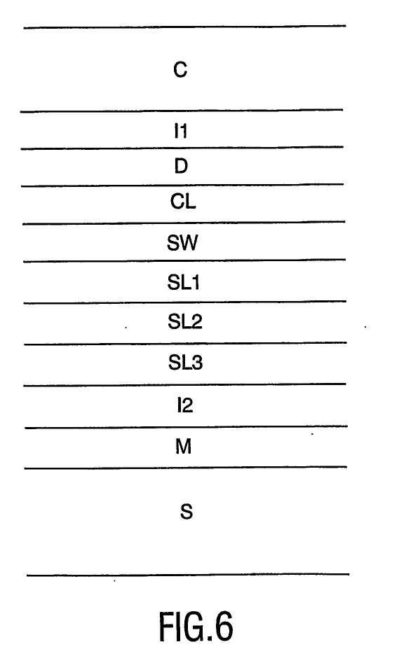

FIG. 6 shows a layer structure on a disk for MO recording with DWDD readout; and

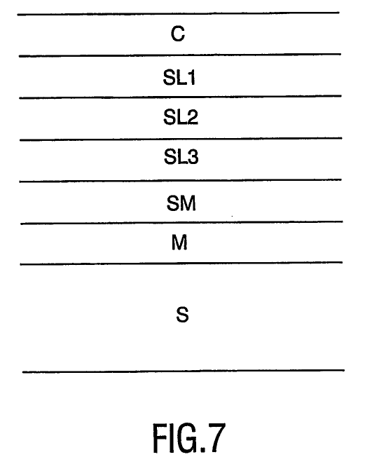

FIG. 7 shows a layer structure on a disk for thermally-assisted magnetic recording.

In FIG. 1 an embodiment is shown of an MO recording and reading system for use with an optical data storage medium 5. The medium 5 comprises a recording stack 9 and has a cover stack 7 that is transparent to a focused radiation beam 1. The wavelength of the radiation beam 1 is 405 nm. The cover layer 7 has a thickness of 10 μm. Said recording stack 9 and cover stack 7 are formed sequentially on a substrate 8 by sputtering and spin coating, respectively. An optical head 3, with an objective 2, having a numerical aperture NA=0.85, from which the focused radiation beam 1 emanates during recording is present at the cover layer 7 side of said optical data storage medium 5. The optical head 3 is adapted for recording/reading at a free working distance of 15 μm from the outermost surface of the medium 5. The optical head 3 incorporates an MFM coil 4 for LP-MFM writing.

FIGS. 2A, 2B and 2C show proposed double-layer structures according to preferred embodiments of the present invention. According to FIG. 2A, a synthetic antiferromagnetically coupled double-layer structure of the form TbFeCo/Ru/TbFeCo is proposed as the storage layer SL. The parameters of the RE-TM alloys, e.g. TbFeCo, are selected so as to obtain an antiparallel configuration in the lowest energy states in the temperature range between room temperature and the Curie or writing temperature. The parameters may be magnetization times thickness product of the TbFeCo layers, coercivities, antiferro-magnetic coupling strength over the Ru layer, etc. FIG. 2B shows a synthetic antiferromagnetically coupled double-layer structure of the form TbFeCo/FeCo/Ru/FeCo/TbFeCo where thin FeCo alloy layers (SL1i, SL3i) are added at the interfaces of TbFeCo and Ru to increase the coupling strength FIG. 2C shows a storage layer embodiment where the sublayers SL1 and SL2 consist of multilayer films of for instance Tb/FeCo or TbFeCo/Pt. The application of multilayers can have an advantages for obtaining a high perpendicular anisotropy or increased Kerr rotation at short wavelengths.

One function of the external field during LP-MFM writing is to orient the magnetization in the heated area in the required direction. Due to the fact that the anisotropy and magnetization are small just below the Curie temperature, this can be accomplished with a quite small external magnetic field. During cooling down, the magnetization increases and there is a possibility that the just recorded area splits up into subdomains. This results in lower carrier levels and increased noise during readout. The subdomain formation can be suppressed by using a sufficiently high external magnetic field. Thus, the optimal writing field is mainly determined by this second process.

FIGS. 3A and 3B show the two antiparallel orientations of the two sublayers SL1, SL3 used for storing the binary information states in the storage layer. In FIG. 3A, the antiparallel magnetic orientations point towards the coupling layer SL2 and in FIG. 3B, the antiparallel magnetic orientations point away from the coupling layer SL2. Due to this antiparallel orientation of the two sublayers SL1, SL3, the overall magnetization is small in the aforementioned temperature range. In principle no external field would be required to suppress subdomain formation.

To enable writing around the Curie temperature, the properties of the two sublayers SL1, SL3 should be chosen slightly different. One possibility is to choose the thickness of two TbFeCo layers SL1, SL3 slightly different. Another possibility is to chose slightly different Curie temperatures so that the layer with the higher Curie temperature can be aligned to the external magnetic field and during cooling down the other layer aligns antiparallel. The binary “1” and “0” states on the disc or recording medium may correspond to the states in FIGS. 3A and 3B, respectively.

A main advantage of the proposed double-layer structure is that the composition of the TbFeCo layers SL1, SL3 can be chosen optimal for obtaining the lowest transition jitter and thereby the highest densities. Thus, both TbFeCo layers SL1, SL3 can have a high anisotropy in contrast to the known methods where the GdFeCo capping layer has a significantly lower anisotropy.

FIG. 4 shows a hysteresis loop of a 20 nm Si₃N₄/15 nm TbFeCo/0.9 nm Ru/10 nm TbFeCo/20 nm Si₃N₄ layer stack measured in a Kerr hysteresis loop tracer at room temperature and a wavelength of 633 μm. In the diagram, the horizontal axis indicates the external field H in kA/m and the vertical axis indicates the Kerr rotation in degrees. The arrows indicate the scanning direction of the field along a certain branch of the hysteresis loop. The compensation temperature and Curie temperature of both TbFeCo sublayers is at −20° C. and 220° C. In fields above 1400 kA/m the both sublayers are oriented in the direction of the external field. Besides the major hysteresis loop also a minor loop is shown. This loop is measured by varying the field strength in-between a value where both layers are oriented in the direction of the external and a value where the layers are in an antiparallel orientation. The major and minor loops show that there are two stable parallel states and two stable antiparallel states at zero-field for this particular combination of magnetization, sublayer thicknesses and coercivity. For larger antiferromagnetic coupling strengths and smaller coercivities of the sublayers only the antiparallel states will become stable in zero-field. The Kerr hysteresis loop also shows that the magnitude of the Kerr rotation is larger for the antiparallel than for the parallel configuration of the sublayers. This is consistent with simulations on the basis of the dielectric tensors of the various materials in the stack. This effect can be exploited to increase the MO readout signal of a storage layer incorporating sublayers with antiparallel magnetization alignment.

FIG. 5 shows a medium for cover-layer incident MO recording according to the configuration of FIG. 1. The stack consists of a metal heat-sink layer (M) of for instance AlCr or Ag, transparent interference layers (I1,I2) of Si₃N₄, storage sublayers (SL1, SL3) of TbFeCo and a Ru coupling layer (SL2). The composition of the TbFeCo sublayers is chosen in such a way that the Curie temperatures are slightly different but close to the writing temperature. The thickness of the two sublayers is chosen substantially the same so that a small overall magnetization is obtained for the storage layer when the sublayers are in the antiparallel alignment. An injection moulded polycarbonate substrate (S) is used and a spin-coated cover layer C of a photo-polymerizable laquer. Thicknesses of the interference layers and metal layer are optimized on readout signal and thermal response during writing.

The proposed double-layer structure may as well be used in an MSR stack. In this case, one of the TbFeCo layers SL1, SL3 can be exchange coupled in the conventional way with the rest of the MSR stack. In case a magneto static coupling as for AC-MAMMOS readout is used, it is essential that the magnetic properties of the two TbFeCo layers SL1, SL3 are sufficiently different at the readout temperature to generate the required stray field. Hence, a compromise has to be found between a low overall magnetization close to the writing temperature to obtain an enhanced field sensitivity and a sufficiently high overall magnetization and stray field at the readout temperature to obtain a good MAMMOS response.

For application of an antiferromagnetically coupled storage layer in a DWDD stack a low stray field at the readout temperature forms a main advantage because the storage layer stray field can no longer disrupt the expansion process in the readout layer. A DWDD embodiment is shown in FIG. 6. For DWDD readout a switching (SW), a control (CL) and a displacement or readout (D) layer are incorporated in the stack structure shown in FIG. 5. The storage sublayer SL1 is exchange coupled in the conventional way with the switching layer. This enables to combine the new storage layer structure with a standard DWDD layer stack based on RB-TM thin-films. For instance, a TbFeAl alloy can be used for the switching layer, a TbFe alloy for the control layer and a GdFeAl layer for the displacement layer. The composition of the TbFeCo storage sublayers is chosen in such a way that the Curie temperatures are slightly different but close to the writing temperature. The thickness of the two sublayers is chosen substantially the same so that a small overall magnetization is obtained close to the writing temperature as well as at the readout temperature. A Ru layer is used as coupling layer (SL2).

FIG. 7 shows a stack configuration for thermally assisted magnetic recording. In-between the storage layer and the heat sink layer a soft-magnetic layer (SM) of for instance NiFe or CoZrNb is included to enhance the field of the write head on the storage layer. On top of the storage layer a thin diamond-like carbon film C incorporated to obtain the required tribological properties during writing and reading with a sliding head. Due to the close proximity of the recording head to the medium, storage sublayer SL1 is mainly involved in the writing and readout process. So even when the sublayers have exactly the same properties, it would still be possible to write and read during thermally assisted magnetic recording in contrast to the MO recording case.

It is noted that the present invention is not restricted to the specific layer structures and recording configurations described before. Any suitable storage layer material can be used to obtain the proposed synthetic antiferromagnetically coupled double-layer structure with antiparallel configuration. Instead of a cover layer incident MO recording configuration also a substrate-incident configuration can be used. The preferred embodiment may thus vary within the scope of the attached claims.

1. A recording medium comprising a storage layer for thermally-assisted writing of information to said recording medium, said storage layer comprising a stack including at least two sub-layers, wherein said sublayers are antiferromagetically coupled through a non-magnetic layer, and wherein at least in a temperature range below the writing temperature the magnitude of the overall magnetization of the storage layer is substantially smaller than the magnitude of the magnetization of each of the sub-layers and said sublayers have an anisotropy favoring around room temperature an orientation of the magnetization perpendicular to the film plane.

2. A recording medium according to claim 1, wherein said non-magnetic layer is a Ru layer.

3. A recording medium according to claim 1, wherein said non-magnetic layer has a thickness in between 0.5 and 1.5 nm.

4. A recording medium according to claim 1 wherein said sub-layers consist of a rare-earth transition-metal alloy including at least Tb and Fe as elements.

5. A recording medium according to claim 1, wherein said sublayers include a thin transition metal layer at the interface with the non-magnetic layer.

6. A recording medium according to claim 1, wherein said sublayers are adapted to have different thicknesses.

7. A recording medium according to claim 1, wherein said sublayers are adapted to have different Curie temperatures.

8. A recording medium according to claim 1, wherein the Kerr rotation or Kerr ellipticity of the recording stack has a larger magnitude for the antiparallel than for the parallel orientation of the sublayer magnetizations.

9. A recording medium according to claim 1, wherein said double-layer structure is incorporated in an MSR stack.

10. A recording medium according to claim 9, wherein said sublayers and non-magnetic layer are part of a DWDD stack and adapted in such a way that the magnitude of the magnetization of the storage layer as a whole at the readout temperature is substantially lower than the magnitude of the magnetization of each sublayer.

11. A recording medium according to claim 9, wherein said recording medium is a MAMMOS recording medium.

12. A method of manufacturing a magneto-optical recording medium, said method comprising the steps of:
a. forming a storage layer by generating an antiferromagnetically coupled double-layer structure comprising two magnetic sub-layers of substantially the same composition and a non-magnetic coupling layer; and
b. setting parameters of said magnetic sub-layers and the non-magnetic coupling layer of said double-layer structure, so as to obtain an antiparallel orientation of magnetization during cooling down from the writing temperature for thermally-assisted recording.
